(19) United States
(12) Patent Application Publication
(10) Pub. No.: US 2005/0009495 A1
(43) Pub. Date: Jan. 13, 2005

(54) Frequency converter using multi-phase mixer

(76) Inventor: Kwang Ho Yoon, Suwon-si (KR)

Correspondence Address: CANTOR COLBURN LLP, 55 Griffin Road South, Bloomfield, CT, 06002, US

(21) Appl. No.: 10/679,773

(22) Filed: Oct. 6, 2003

(30) Foreign Application Priority Data
Jul. 11, 2003 (KR) 2003-0047052

(51) Int. Cl. H04B 1/26; H04B 15/00

(52) U.S. Cl. 455/323; 455/318; 455/313

(57) ABSTRACT

Disclosed herein is a frequency converter using a multi-phase mixer. The frequency converter of the present invention includes an oscillator, and a mixer for down-modulating the frequency of an RF communication signal to provide a modulated output signal. The mixer includes an input unit responding to the RF communication signal, and a driving unit for controlling current signals in response to the clock signals to generate the modulated output signal. The frequency converter using the multi-phase mixer generates an output signal with a frequency approximate to that of a DC signal by greatly decreasing the frequency of a received RF communication signal even though a clock signal with a relatively low frequency is used.

### BACKGROUND OF THE INVENTION

1. Field of the Invention

The present invention relates generally to a frequency converter and, more particularly, to a frequency converter employing a multi-phase mixer to down-modulate an input signal.

2. Description of the Related Art

A Radio Frequency (RF) communication system is applied to various communication fields, such as a Personal Communication Service (PCS) system and an International Mobile Telecommunication (IMT) system. Generally, an RF communication system is comprised of an RF front-end block and a base-band Digital Signal Processing (DSP) block. At the current technological level, the base-band DSP block can be implemented to cost low and to consume power less.

In particular, the RF front-end block includes a frequency converter that up-modulates or down-modulates the frequency of an input RF communication signal and generates the modulated signal as an output signal. FIG. 1 is a schematic diagram illustrating a conventional frequency converter, and FIG. 2 is a timing diagram for describing the operation of the frequency converter of FIG. 1. In the frequency converter of FIG. 1, an input RF communication signal RF gates a transistor 21 of a mixer 20 and is output in the form of a current signal at junction node N22. An oscillation signal LO and an inverted oscillation signal LOB generated by an oscillator 10 gate transistors 23 and 24, respectively, thus alternately switching the transistors 23 and 24 to be conducting or non-conducting state. Therefore, the mixer 20 enables signals, output from the junction node N22 of the transistor 21 and the transistors 23 and 24 to positive and negative output terminals VOUT+ and VOUT−, to be alternately converted every half period T/2, as shown in FIG. 2.

Therefore, frequency-converted output current signals are output through the transistors 23 and 24, and transmitted as voltage signals in a load circuit 27. The difference between voltages on the positive and negative output terminals VOUT+ and VOUT−, generated through the above procedure, generates a modulated output signal VOUT. Further, the frequency of the modulated output signal VOUT is increased or decreased compared to that of the RF communication signal RF. The intensity of the modulated output signal VOUT is determined depending on the frequency of the oscillation signal LO. The signals output through the positive and negative output terminals VOUT+ and VOUT− contain together the components of the RF communication signal RF and the oscillation signal LO.

In the meantime, in order to down-convert the high frequency of the RF communication signal RF so that the RF communication signal RF approximates to a Direct Current (DC) signal, the oscillation signal LO and the inverted oscillation signal LOB should be operated to generate a high frequency fₒ approximate to that of the RF communication signal RF.

However, recent RF communication systems, such as a Bluetooth system and a Code Division Multiple Access (CDMA) system, are operated at a frequency equal to or greater than 2 GHz. Some communication systems supporting wireless Local Area Network (LAN) standards are operated at a frequency equal to or greater than 5 GHz. It is very difficult to design a frequency converter including an oscillator and a mixer on a single chip using a Complementary Metal Oxide Semiconductor (CMOS) manufacturing process having relative limitations in speed and noise with respect to communication systems operated at high frequencies as described above. To solve this problem, there has been a development such as implementing an RF front-end block including a frequency converter using bipolar or bi-CMOS technologies. However, in the case where such a bi-CMOS technology is used, there are still other problems in that high costs are required and power consumption is increased compared to a CMOS technology.

### SUMMARY OF THE INVENTION

Accordingly, the present invention has been made keeping in mind the above problems occurring in the prior art, and an object of the present invention is to provide a frequency converter, which can generate an output signal with a frequency approximate to that of a DC signal by greatly decreasing the frequency of a received RF communication signal while using an oscillation signal with a relatively low frequency.

In order to accomplish the above and other objects, the present invention provides a frequency converter comprising an oscillator for generating N clock signals with a predetermined oscillation frequency, in which the N clock signals have phases sequentially shifted and the clock signals each include an oscillation signal and an inverted oscillation signal having an inverted phase with respect to the oscillation signal; and a mixer for receiving a predetermined radio frequency (RF) communication signal and providing a modulated output signal by down-modulating a frequency of the RF communication signal using the N clock signals. The mixer comprises a load unit including a first load element arranged between a predetermined supply voltage and a positive output terminal and a second load element arranged between the supply voltage and a negative output terminal, the load unit generating the modulated output signal according to a voltage difference between signals provided to the positive and negative output terminals, an input unit responding to the RF communication signal, and a driving unit coupled to the input unit for controlling current signals flowing through the first and second load elements, respectively, in response to the N clock signals to generate the modulated output signal.

### BRIEF DESCRIPTION OF THE DRAWINGS

The above and other objects, features and advantages of the present invention will be more dearly understood from the following detailed description taken in conjunction with the accompanying drawings, in which:

FIG. 1 is a circuit diagram of a conventional frequency converter;

FIG. 2 is a timing diagram showing the operation of the frequency converter of FIG. 1;

FIGS. 3A and 3B are a block diagram and a circuit diagram, respectively, of a frequency converter according to an embodiment of the present invention;

FIG. 4 is a timing diagram showing the operation of the frequency converter of FIGS. 3A and 3B;

FIGS. 5A and 5B are a block diagram and a circuit diagram, respectively, of a frequency converter according to another embodiment of the present invention;

FIGS. 6A and 6B are a block diagram and a circuit diagram, respectively, of a frequency converter according to further another embodiment of the present invention;

FIG. 7 is a circuit diagram showing the frequency converter of FIG. 6B in a different manner; and

FIG. 8A is a block diagram of a frequency converter according to still another embodiment of the present invention, and FIG. 8B is a circuit diagram of a mixer of FIG. 8A.

### DETAILED DESCRIPTION OF THE INVENTION

Reference now should be made to the drawings, in which the same reference numerals are used throughout the different drawings to designate the same or similar components.

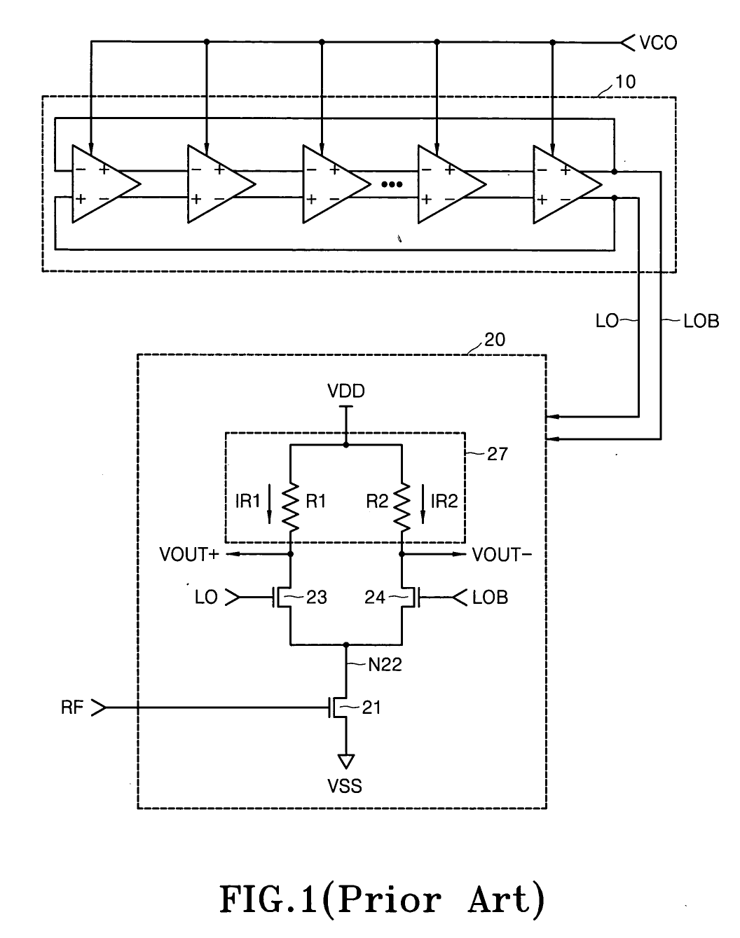

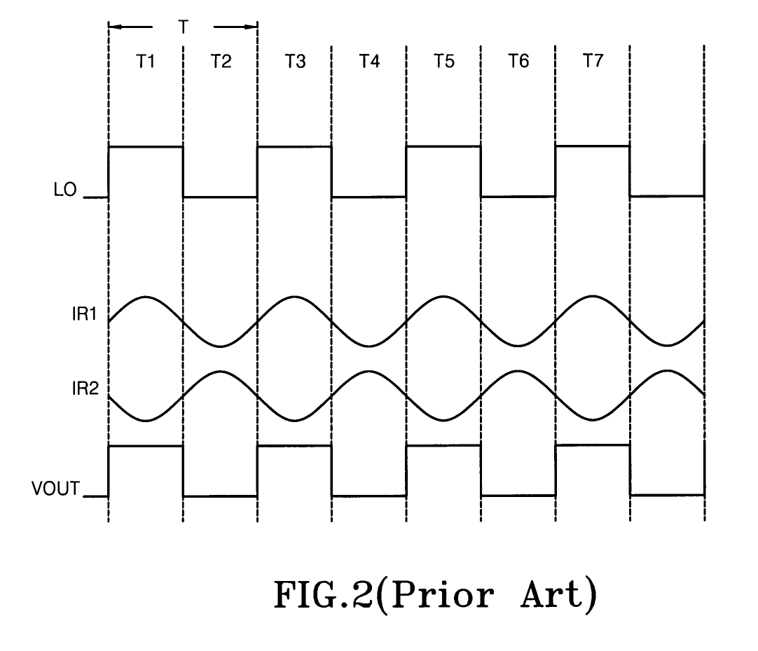

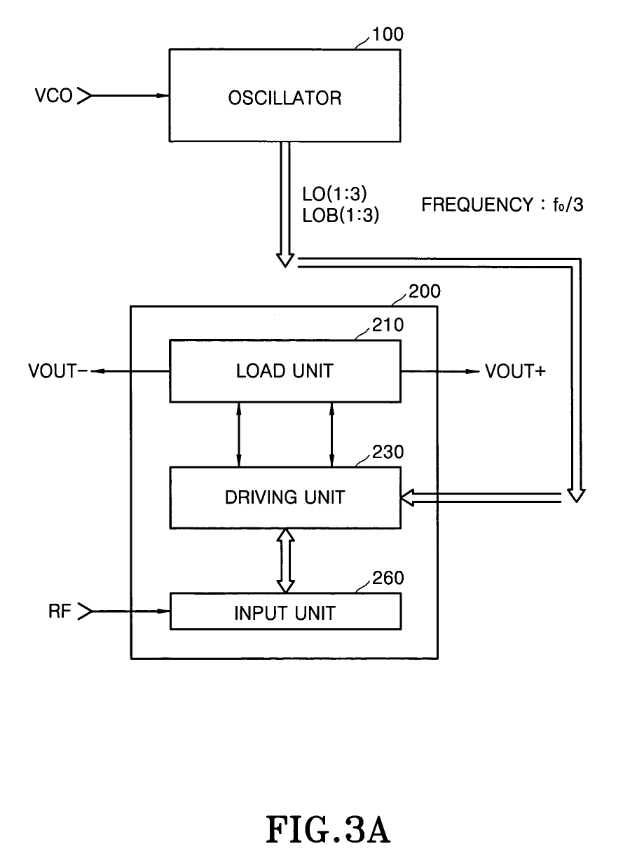

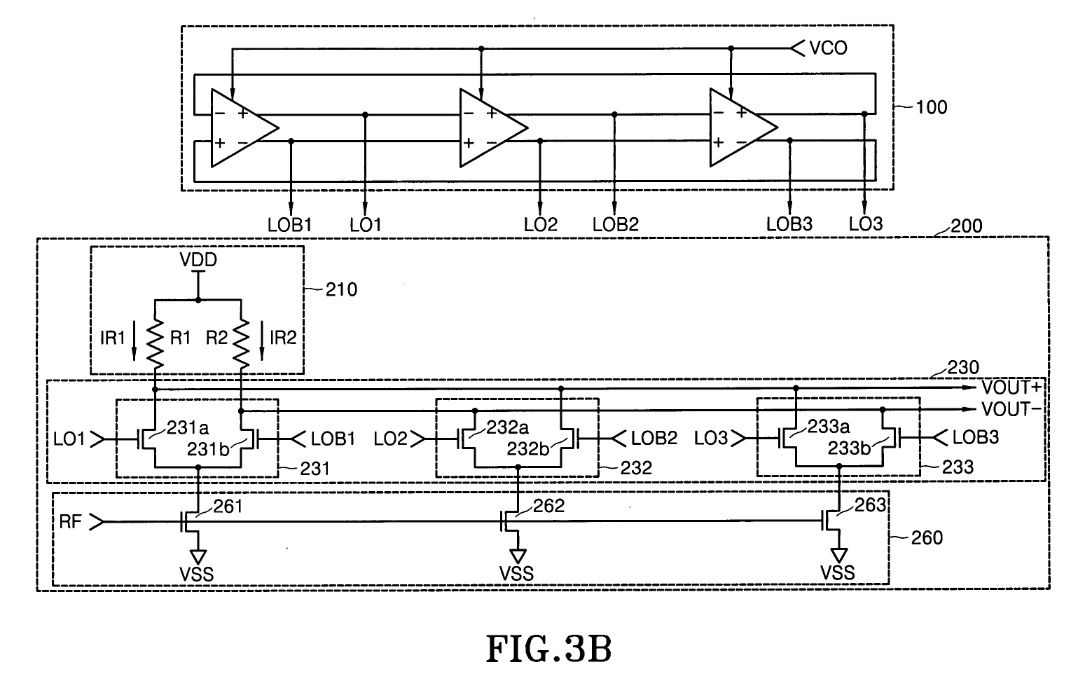

FIGS. 3A and 3B are a block diagram and a circuit diagram, respectively, of a frequency converter according to an embodiment of the present invention. Referring to FIGS. 3A and 3B, the frequency converter of the present invention includes an oscillator 100 and a mixer 200. The oscillator 100 generates first to third oscillation signals LO1 to LO3 and first to third inverted oscillation signals LOB1 to LOB3. In this case, the first to third oscillation signals LO1 to LO3 each have an oscillation frequency fₒ/3, which is approximately ⅓ of the frequency f₀ of a conventional oscillation signal shown in FIG. 1, and have sequentially shifted phases. The first to third inverted oscillation signals LOB1 to LOB3 are signals having inverted phases with respect to the first to third oscillation signals LO1 to LO3, respectively. Further, in the present specification, the respective pairs of the first to third oscillation signals LO1 to LO3 and the first to third inverted oscillation signals LOB1 to LOB3 are designated as “first to third clock signals.”

The mixer 200 receives a predetermined RF communication signal RF. Further, the mixer 200 down-modulates the frequency of the received RF communication signal RF using the first to third clock signals to provide a modulated output signal VOUT. Although not shown in FIGS. 3A and 3B, the modulated output signal VOUT represents a signal obtained according to the voltage difference between signals provided to positive and negative output terminals VOUT+ and VOUT−.

Specifically, the mixer 200 includes a load unit 210, a driving unit 230 and an input unit 260. The load unit 210 includes a first load element R1 arranged between a supply voltage VDD and the positive output terminal VOUT+, and a second load element R2 arranged between the supply voltage VDD and the negative output terminal VOUT−. For example, the first and second load elements R1 and R2 each include a resistor.

The input unit 260 responds to the RF communication signal RF. More specifically, the input unit 260 includes first to third source stages 261 to 263 gated in response to the RF communication signal RF.

The driving unit 230 is coupled to the input unit 260. Further, the driving unit 230 controls current signals IR1 and IR2 flowing through the first and second load elements R1 and R2 in response to the first to third clock signals, that is, the first to third oscillation signals LO1 to LO3 and the first to third inverted oscillation signals LOB1 to LOB3, thus generating the modulated output signal VOUT.

More specifically, the driving unit 230 includes first to third driving stages 231 to 233 coupled to the first to third source stages 261 to 263, respectively. Each of the first to third driving stages 231 to 233 includes a first transistor 231a, 232a or 233a and a second transistor 231b, 232b or 233b. The first transistors 231a to 233a of the first to third driving stages 231 to 233 are gated in response to the first to third oscillation signals LO1 to LO3, respectively, and the second transistors 231b to 233b of the first to third driving stages 231 to 233 are gated in response to the first to third inverted oscillation signals LOB1 to LOB3, respectively. In each of the first to third driving stages 231 to 233, the first and second transistors are connected to each other at a junction where their one side ends are met. The first to third source stages 261 to 263 are each connected to the junction of corresponding one of the first to third driving stages 231 to 233.

Further, the other side ends of each pair of the first transistor 231a, 232a or 233a and the second transistor 231b, 232b or 233b are electrically connected to the positive and negative output terminals VOUT+ and VOUT−, respectively, such that the connection of the other side ends of one driving stage is contrary to that of its adjacent driving stage. This construction is described in detail below.

First, the first transistor 231a of the first driving stage 231 is arranged between the first source stage 261 and the positive output terminal VOUT+, and the second transistor 231b thereof is arranged between the first source stage 261 and the negative output terminal VOUT−.

The first transistor 232a of the second driving stage 232 is arranged between the second source stage 262 and the negative output terminal VOUT−, and the second transistor 232b thereof is arranged between the second source stage 262 and the positive output terminal VOUT+.

The first transistor 233a of the third driving stage 233 is arranged between the third source stage 263 and the positive output terminal VOUT+, and the second transistor 233b thereof is arranged between the third source stage 263 and the negative output terminal VOUT−.

In this embodiment, the first transistors 231a to 233a and the second transistors 231b to 233b have the substantially same electrical characteristics.

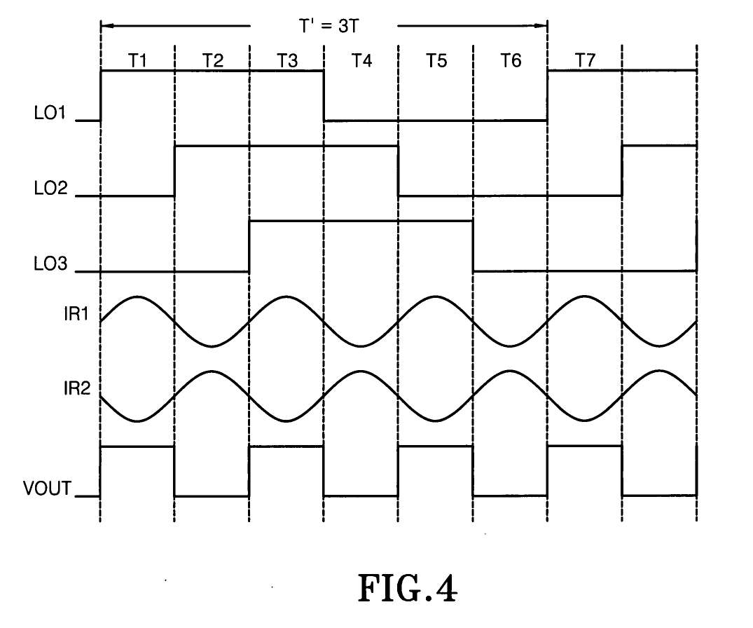

FIG. 4 is a timing diagram showing the operation of the frequency converter using a multi-phase mixer of FIGS. 3A and 3B. The operation of the frequency converter of the present invention is described with reference to FIGS. 3A and 3B and FIG. 4. As described above, an oscillation frequency of the oscillation signals LO1 to LO3 and the inverted oscillation signals LOB1 to LOB3 generated by the oscillator 100 is fₒ/3, which is ⅓ of oscillation frequency fₒ of a conventional oscillation signal (LO of FIG. 1), and period T′ thereof is 3T which is three times period T of the conventional oscillation signal. Further, the phases of the oscillation signals LO1 to LO3 and the inverted oscillation signals LOB1 to LOB3 are sequentially shifted by ⅙ of the period T′, that is, T/2.

During interval T1, the first oscillation signal LO1 is logic “high”, and the second and third oscillation signals LO2 and LO3 are logic “low”. Thus, the first transistor 231a of the first driving stage 231, the second transistor 232b of the second driving stage 232, and the second transistor 233b of the third driving stage 233 are turned on. That is, the two transistors 231a and 232b connected to the positive output terminal VOUT+, and one transistor 233b connected to the negative output terminal VOUT− are turned on. Consequently, the current IR1 flowing through the first load element R1 becomes greater than the current IR2 flowing through the second load element R2.

Meanwhile, during interval T2 where the period T′ is shifted, the first and second oscillation signals LO1 and LO2 are logic “high”, and the third oscillation signal LO3 is logic “low”. Therefore, the first transistor 231a of the first driving stage 231, the first transistor 232a of the second driving stage 232, and the second transistor 233b of the third driving stage 233 are turned on. That is, one transistor 231a connected to the positive output terminal VOUT+ and two transistors 232a and 233b connected to the negative output terminal VOUT− are turned on. Consequently, the current IR1 flowing through the first load element R1 becomes less than the current IR2 flowing through the second load element R2.

Further, during interval T3, all the first to third oscillation signals LO1 to LO3 are logic “high”. Therefore, the first transistors 231a to 233a of the first to third driving stages 231 to 233 are turned on. That is, the two transistors 231a and 233a connected to the positive output terminal VOUT+ and one transistor 232a connected to the negative output terminal VOUT− are turned on. Consequently, the current IR1 flowing through the first load element R1 becomes greater than the current IR2 flowing through the second load element R2.

Through the above method, during intervals T1, T3, T5, T7, . . . , the current IR1 flowing through the first load element R1 is greater than the current IR2 flowing through the second load element R2, while during intervals T2, T4, T6, . . . , the current IR1 flowing through the first load element R1 is less than the current IR2 flowing through the second load element R2.

Therefore, the modulated output signal VOUT generated according to the voltage difference between voltage signals output from the positive and negative output terminals VOUT+ and VOUT− becomes a signal having period T, similar to the conventional frequency converter. In other words, although using the oscillation signal with frequency fₒ/3, which is ⅓ of the frequency fₒ of the conventional oscillation signal, the frequency converter using a multi-phase mixer of the present invention obtains the same operation and effect as the conventional frequency converter using the oscillation signal with the frequency fₒ.

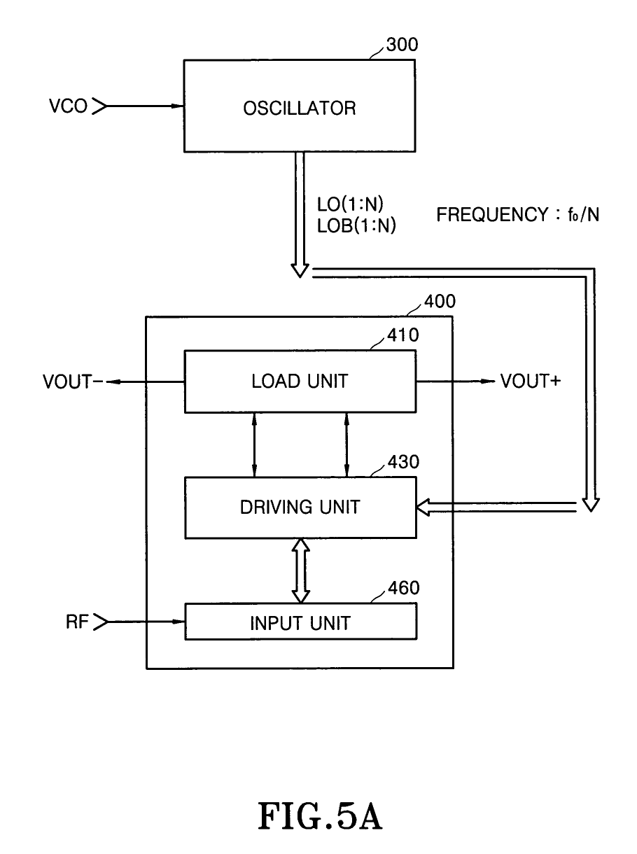

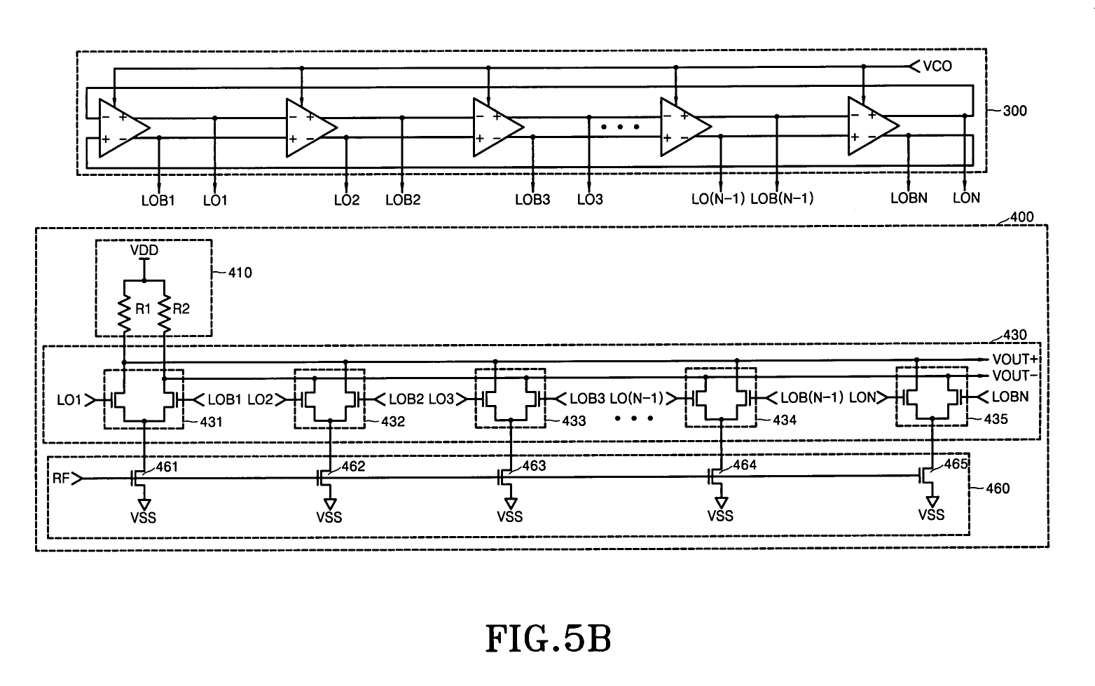

FIGS. 5A and 5B are a block diagram and a circuit diagram, respectively, of a frequency converter according to another embodiment of the present invention. Referring to FIGS. 5A and 5B, N oscillation signals LO1 to LON and N inverted oscillation signals LOB1 to LOBN are generated by an oscillator 300. In this case, the oscillation signals LO1 to LON and the inverted oscillation signals LOB1 to LOBN have an oscillation frequency fₒ/N, and phases sequentially shifted by T′/2N. Further, an input unit 460 includes N source stages 461, 462, . . . , and a driving unit 430 includes N driving stages 431, 432, . . . . The frequency converter of FIGS. 5A and 5B is an extended embodiment of that of FIGS. 3A and 3B. Since the construction and operation of the frequency converter in FIGS. 5A and 5B are substantially similar to those of the frequency converter in FIGS. 3A and 3B, a detailed description of the equivalent parts will be omitted.

In the frequency converter of FIGS. 5A and 5B, the oscillation signal generated from the oscillator 300 has frequency fₒ/N, which is 1/N of the frequency fₒ of the conventional oscillation signal, and the frequency converter obtains the modulated output signal VOUT having frequency fₒ.

In the frequency converter of FIGS. 5A and 5B, N is an any integer. For example, effective performance can be obtained when N is three as in the embodiment of FIGS. 3A and 3B, if the easiness of a circuit design or the like is taken into consideration.

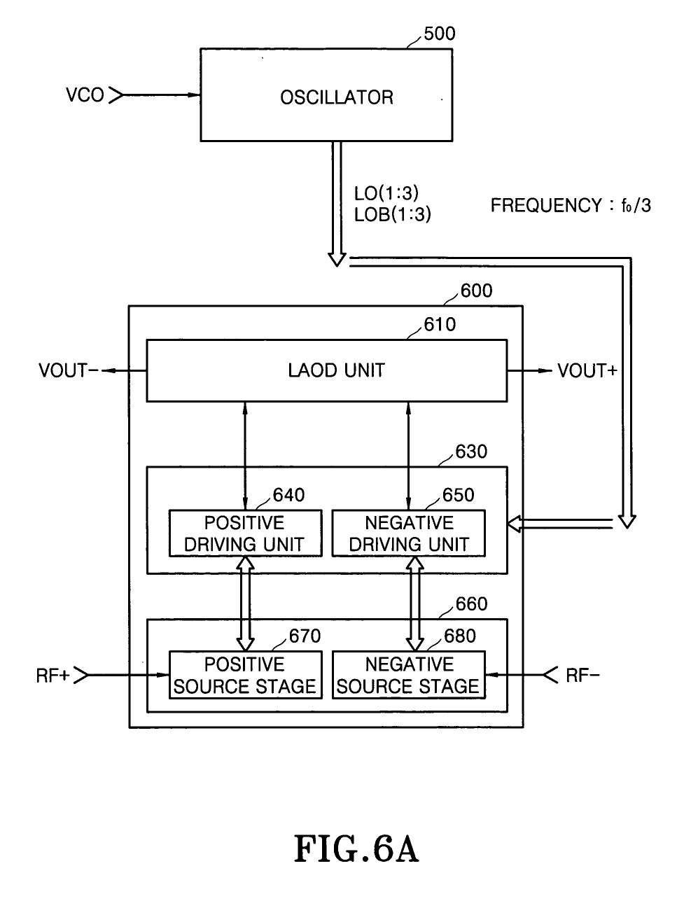

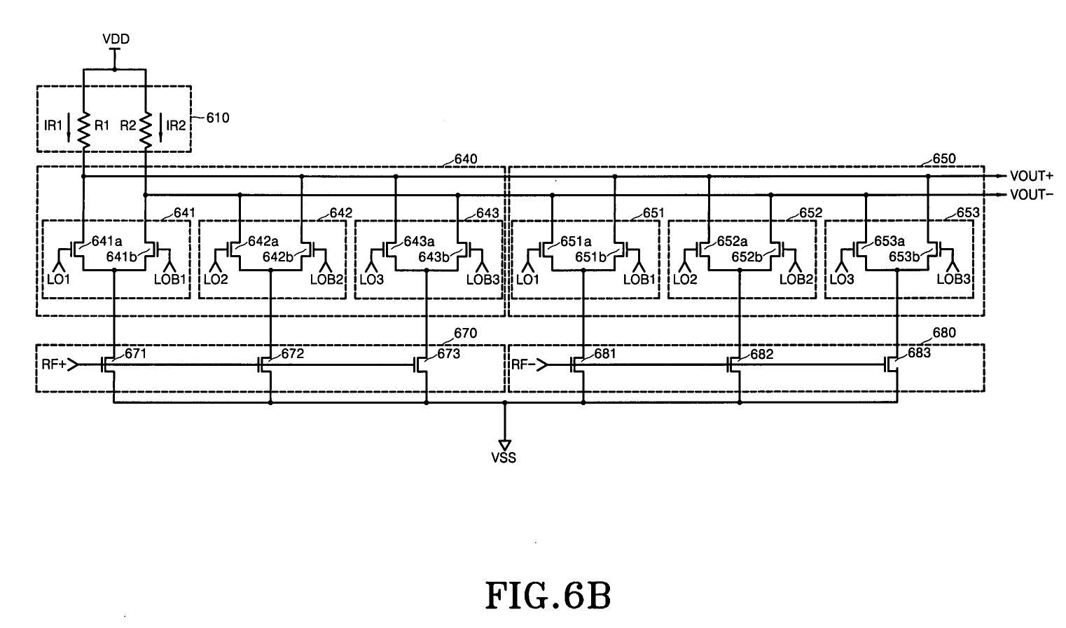

FIGS. 6A and 6B are a block diagram and a circuit diagram, respectively, of a frequency converter according to a further embodiment of the present invention. FIGS. 6A and 6B show a modified embodiment of that of FIGS. 3A and 3B. That is, the embodiment of FIGS. 3A and 3B represents a single-balanced frequency converter, while the embodiment of FIGS. 6A and 6B represents a double-balanced frequency converter.

Similar to the embodiment of FIGS. 3A and 3B, the frequency converter according to the embodiment of FIGS. 6A and 6B includes an oscillator 500 and a mixer 600. The oscillator 500 of FIGS. 6A and 6B is implemented in the same manner as the oscillator 100 of FIGS. 3A and 3B. The mixer 600 includes a load unit 610, a driving unit 630 and an input unit 660. The load unit 610 of FIGS. 6A and 6B is implemented in the same manner as the load unit 210 of FIGS. 3A and 3B.

The input unit 660 includes first to third positive source stages 671 to 673 responding to an RF communication signal RF+, and first to third negative source stages 681 to 683 responding to an inverted RF communication signal RF−. The inverted RF communication signal RF− has an inverted phase with respect to the RF communication signal RF+. Therefore, the reference character of the RF communication signal is represented by RF+ in consideration of the inverted RF communication signal RF−.

The driving unit 630 includes first to third positive driving stages 641 to 643 and first to third negative driving stages 651 to 653. The first to third positive driving stages 641 to 643 are equal to the first to third driving stages 231 to 233 of FIG. 3B. That is, each of the first to third positive driving stages 641 to 643 includes a first transistor 641a, 642a or 643a and a second transistor 641b, 642b or 643b. The first transistors 641a to 643a are gated in response to oscillation signals LO1 to LO3, respectively, and the second transistors 641b to 643b are gated in response to inverted oscillation signals LOB1 to LOB3, respectively. The junctions of one side ends of the respective pairs of the first transistors 641a to 643a and the second transistors 641b to 643b are connected to the positive source stages 671 to 673, respectively, and controlled thereby.

The other side ends of each pair of the first transistor 641a, 642a or 643a and the second transistor 641b, 642b or 643b are electrically connected to positive and negative output terminals VOUT+ and VOUT−, respectively, such that the connection of the other side ends thereof is contrary to that of its adjacent positive driving stage.

Each of the first to third negative driving stages 651 to 653 includes a third transistor 651a, 652a or 653a and a fourth transistor 651b, 652b or 653b. The third transistors 651a to 653a are gated in response to the oscillation signals LO1 to LO3, respectively, and the fourth transistors 651b to 653b are gated in response to the inverted oscillation signals LOB1 to LOB3, respectively. The junctions of one side ends of the respective pairs of the third transistors 651a to 653a and the fourth transistors 651b to 653b are connected to negative source stages 681 to 683, respectively, and controlled thereby.

The other side ends of each pair of the third transistor 651a, 652a or 653a and the fourth transistor 651b, 652b or 653b are electrically connected to the positive and negative output terminals VOUT+ and VOUT−, respectively, such that the connection of the other side ends thereof is contrary to that of its adjacent positive driving stage. Further, the connection of the other side ends of the respective pairs of the third transistors 651a to 653a and the fourth transistors 651b to 653b, included in the first to third negative driving stages 651 to 653, are contrary to that of the other ends of the respective pairs of the first transistors 641a to 643a and the second transistors 641b to 643b, included in the first to third positive driving stages 641 to 643. This construction is described in detail below.

The third transistor 651a of the first negative driving stage 651 is arranged between the first negative source stage 681 and the negative output terminal VOUT−, and the fourth transistor 651b thereof is arranged between the first negative source stage 681 and the positive output terminal VOUT+.

The third transistor 652a of the second negative driving stage 652 is arranged between the second negative source stage 682 and the positive output terminal VOUT+, and the fourth transistor 652b thereof is arranged between the second negative source stage 682 and the negative output terminal VOUT−.

Further, the third transistor 653a of the third negative driving stage 653 is arranged between the third negative source stage 683 and the negative output terminal VOUT−, and the fourth transistor 653b thereof is arranged between the third negative source stage 683 and the positive output terminal VOUT+.

Since the construction, operation and effect of the frequency converter of FIGS. 6A and 6B can be easily understood from the embodiment of FIGS. 3A and 3B, a detailed description thereof is omitted.

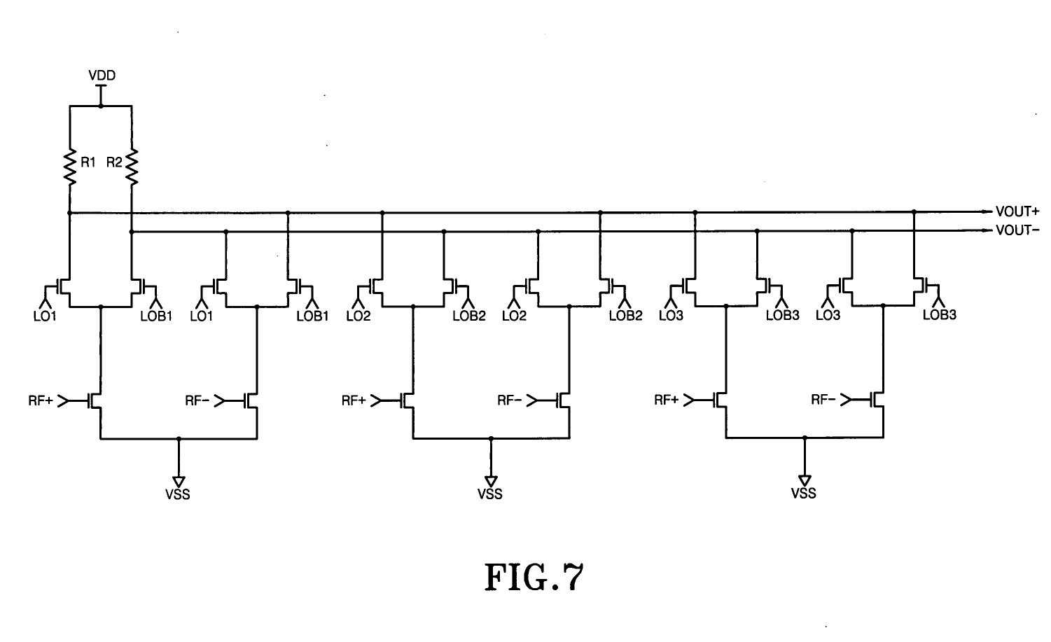

FIG. 7 is a circuit diagram showing the frequency converter of FIG. 6B in a different manner for a better understanding of this embodiment. As shown in FIG. 7, the positive and negative driving stages are controlled in response to the same oscillation signals LO1 to LO3 and inverted oscillation signals LOB1 to LOB3, and the respective pairs of the positive and negative driving stages are arranged in parallel with respect to the load unit.

Although in the embodiment of FIGS. 6A and 6B and FIG. 7, the number of oscillation signals is three as an example, the number of oscillation signals can be increased similar to the embodiment of FIGS. 5A and 5B.

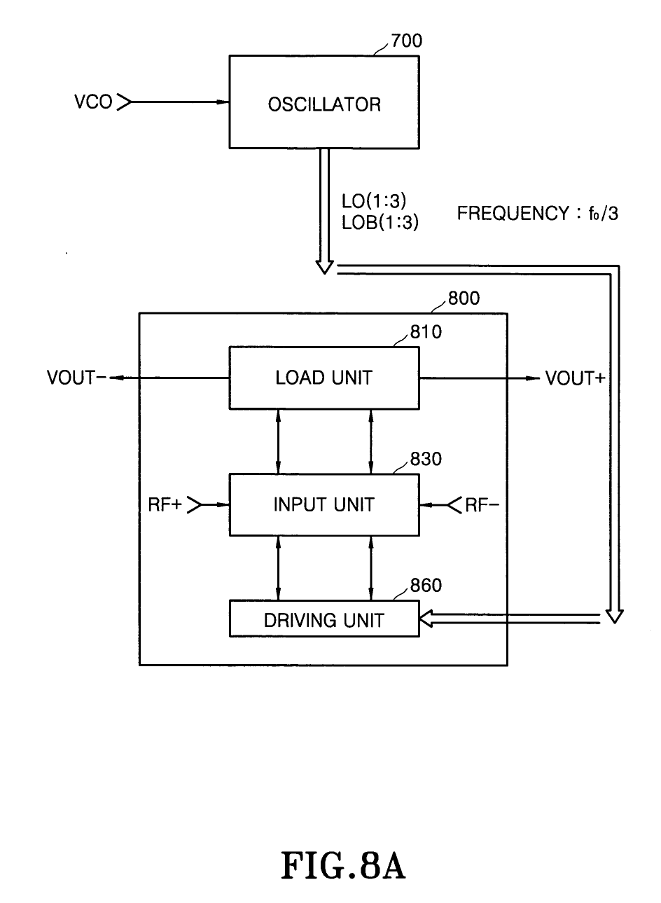

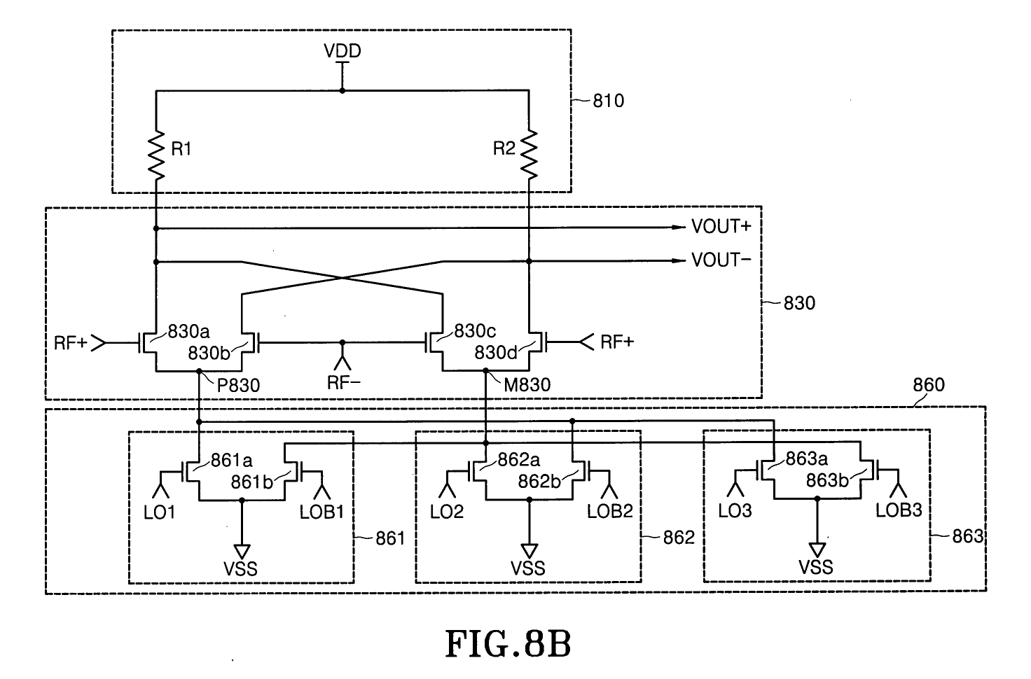

FIG. 8A is a block diagram of a frequency converter according to still another embodiment of the present invention, and FIG. 8B is a circuit diagram of a mixer 800 of FIG. 8A. FIGS. 8A and 8B show a modified embodiment of that of FIGS. 3A and 3B.

The frequency converter according to the embodiment of FIG. 8A includes an oscillator 700 and a mixer 800, similar to the embodiment of FIG. 3A. The oscillator 700 of FIG. 8A is implemented in the same manner as the oscillator 100 of FIG. 3A.

Referring to FIGS. 8A and 8B, the mixer 800 includes a load unit 810, an input unit 830 and a driving unit 860. The load unit 810 of FIGS. 8A and 8B is implemented in the same manner as the load unit 210 of FIGS. 3A and 3B.

Meanwhile, the input unit 830 includes first to fourth input transistors 830a to 830d forming a latch. The construction of the first to fourth input transistors 830a to 830d is described in detail below.

The first input transistor 830a is gated in response to a received RF communication signal RF+ and arranged between a positive output terminal VOUT+ and a predetermined positive auxiliary terminal P830. The second input transistor 830b is gated in response to an inverted RF communication signal RF− and arranged between a negative output terminal VOUT− and the positive auxiliary terminal P830. The inverted RF communication signal RF− has an inverted phase with respect to the RF communication signal RF+, as described above.

The third input transistor 830c is gated in response to the inverted RF communication signal RF−, and arranged between the positive output terminal VOUT+ and a predetermined negative auxiliary terminal M830. Further, the fourth input transistor 830d is gated in response to the RF communication signal RF+ and arranged between the negative output terminal VOUT− and the negative auxiliary terminal M830.

The driving unit 860 includes first to third driving stages 861 to 863. Each of the first to third driving stages 861 and 863 includes a first driving transistor 861a, 862a or 863a and a second driving transistor 861b, 862b or 863b. The first driving transistors 861a to 863a are gated in response to oscillation signals LO1 to LO3, respectively, and the second driving transistors 861b to 863b are gated in response to inverted oscillation signals LOB1 to LOB3, respectively. The junctions of one side ends of the respective pairs of the first driving transistors 861a to 863a and the second driving transistors 861b to 863b are connected to a ground voltage VSS and controlled. Further, in a modified embodiment of the present invention, current sources can be internally arranged between the first to third driving stages and the ground voltage VSS.

Further, the other side ends of each pair of the first driving transistor 861a, 862a or 863a and the second driving transistor 861b, 862b or 863b are electrically connected to the positive and negative auxiliary terminals P830 and M830, respectively, such that the connection of the other side ends thereof is contrary to that of its adjacent driving stage. This construction is described in detail below.

The first driving transistors 861a and 863a of the first and third driving stages 861 and 863 are arranged between the ground voltage VSS and the positive auxiliary terminal P830, and the second driving transistors 861b and 863b thereof are arranged between the ground voltage VSS and the negative auxiliary terminal M830.

In the meantime, the first driving transistor 862a of the second driving stage 862 is arranged between the ground voltage VSS and the negative auxiliary terminal M830, and the second driving transistor 862b thereof is arranged between the ground voltage VSS and the positive auxiliary terminal P830.

Since the construction, operation and effect of the frequency converter of FIGS. 8A and 8B can be easily understood from the embodiment of FIGS. 3A and 3B, a detailed description thereof is omitted.

Although in the embodiment of FIGS. 8A and 8B, the number of oscillation signals is three as an example, the number of oscillation signals can be increased similar to the embodiment of FIGS. 5A and 5B.

As described above, a frequency converter using a multi-phase mixer according to the present invention can generate an output signal with a frequency approximate to that of a DC signal by greatly decreasing the frequency of a received RF communication signal even though a clock signal with a relatively low frequency is used. Therefore, the frequency converter of the present invention can be implemented through a CMOS technology having advantages of lower costs and low power consumption relative to other technologies.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A frequency converter, comprising:
an oscillator for generating N clock signals with a predetermined oscillation frequency, the N clock signals having phases sequentially shifted, each of the clock signals including an oscillation signal and an inverted oscillation signal having an inverted phase with respect to the oscillation signal; and
a mixer for receiving a predetermined radio frequency (RF) communication signal and providing a modulated output signal by down-modulating a frequency of the RF communication signal using the N clock signals, wherein the mixer comprises:
a load unit including a first load element arranged between a predetermined supply voltage and a positive output terminal and a second load element arranged between the supply voltage and a negative output terminal, the load unit generating the modulated output signal according to a voltage difference between signals provided to the positive and negative output terminals;
an input unit responding to the RF communication signal; and
a driving unit coupled to the input unit for controlling current signals flowing through the first and second load elements, respectively, in response to the N clock signals to generate the modulated output signal.

2. The frequency converter according to claim 1, wherein:
the input unit includes N source stages each responding to the RF communication signal; and
the driving unit includes N driving stages each having a first transistor responding to the oscillation signal of corresponding one of the clock signals and a second transistor responding to the inverted oscillation signal of the corresponding one of the clock signals, the first and second transistors having first side ends connected to corresponding one of the source stages and second side ends electrically connected to the positive and negative output terminals, respectively, such that a connection of the second side ends of the first and second transistors of a driving stage is contrary to that of an adjacent driving stage.

3. The frequency converter according to claim 2, wherein the N is three.

4. The frequency converter according to claim 2, wherein the source stages each include a transistor that is controlled by the RF communication signal and has a conduction path between corresponding one of the driving stages and a ground voltage.

5. The frequency converter according to claim 4, wherein the first transistor is gated by the oscillation signal and has a conduction path between the first load element and the transistor of corresponding one of the source stages, and the second transistor is gated by the inverted oscillation signal and has a conduction path between the second load element and the transistor of the corresponding one of the source stages.

6. The frequency converter according to claim 1, wherein the input unit includes:
N positive source stages each responding to the RF communication signal; and
N negative source stages each responding to an inverted RF communication signal having an inverted phase with respect to the RF communication signal.

7. The frequency converter according to claim 6, wherein the driving unit includes:
N positive driving stages each having a first transistor responding to the oscillation signal of corresponding one of the clock signals and a second transistor responding to the inverted oscillation signal of the corresponding one of the clock signals, the first and second transistors having first side ends connected to corresponding one of the positive source stages and second side ends electrically connected to the positive and negative output terminals, respectively, such that a connection of the second side ends of the first and second transistors of a positive driving stage is contrary to that of an adjacent positive driving stage; and
N negative driving stages each having a third transistor responding to the oscillation signal of corresponding one of the clock signals and a fourth transistor responding to the inverted oscillation signal of the corresponding one of the clock signals, the third and fourth transistors having first side ends connected to corresponding one of the negative source stages and second side ends electrically connected to the positive and negative output terminals, respectively, such that a connection of the second side ends of the third and fourth transistors of a negative driving stage is contrary to that of the first and second transistors of corresponding one of the positive driving stages.

8. The frequency converter according to claim 7, wherein the N is three.

9. The frequency converter according to claim 1, wherein the input unit includes:
a first input transistor arranged between the positive output terminal and a positive auxiliary terminal to respond to the RF communication signal;
a second input transistor arranged between the negative output terminal and the positive auxiliary terminal to respond to an inverted RF communication signal having an inverted phase with respect to the RF communication signal;
a third input transistor arranged between the positive output terminal and a negative auxiliary terminal to respond to the inverted RF communication terminal; and
a fourth input transistor arranged between the negative output terminal and the negative auxiliary terminal to respond to the RF communication signal.

10. The frequency converter according to claim 9, wherein the driving unit includes N driving stages each having a first driving transistor responding to the oscillation signal of corresponding one of the clock signals and a second driving transistor responding to the inverted oscillation signal of the corresponding one of the clock signals, the first and second driving transistors having first side ends connected to a ground voltage and second side ends electrically connected to the positive and negative auxiliary terminals, respectively, such that a connection of the second side ends of the first and second driving transistors of a driving stage is contrary to that of an adjacent driving stage.

11. The frequency converter according to claim 10, wherein the N is three.

12. The frequency converter according to claim 10, wherein the first input transistor is gated by the RF communication signal and has a conduction path between the first load element and the positive auxiliary terminal, the second input transistor is gated by the inverted RF communication signal and has a conduction path between the second load element and the positive auxiliary terminal, the third input transistor is gated by the inverted RF communication signal and has a conduction path between the first load element and the negative auxiliary terminal, and the fourth input transistor is gated by the RF communication signal and has a conduction path between the second load element and the negative auxiliary terminal.
